(19) United States
(12) Patent Application Publication
(10) Pub. No.: US 2024/0410781 A1
(43) Pub. Date: Dec. 12, 2024

(54) HOT-HUMID CLIMATIC WIND TUNNEL AND MULTI-FIELD COUPLING CONTROL SYSTEM THEREFOR

(71) Applicants: SOUTH CHINA UNIVERSITY OF TECHNOLOGY, Guangzhou City (CN); GUANGZHOU SIHONG TECHNOLOGY COMPANY, Guangzhou City (CN)

(72) Inventors: Qinglin MENG, Guangzhou City (CN); Qiong LI, Guangzhou City (CN); Junsong WANG, Guangzhou City (CN); Lingling LI, Guangzhou City (CN); Huijun MAO, Guangzhou City (CN); Shaoliang WEI, Guangzhou City (CN)

(21) Appl. No.: 18/706,628

(22) PCT Filed: Jul. 3, 2020
(86) PCT No.: PCT/CN2020/100092

§ 371 Date: May 1, 2024

(30) Foreign Application Priority Data
Oct. 30, 2019 (CN) 201911043370.2

(51) Int. Cl. G01M 9/04; G01M 9/06

(52) U.S. Cl. CPC G01M 9/04; G01M 9/065

(57) ABSTRACT

A hot-humid climatic wind tunnel and a multi-field coupling control system therefor. A fan (18), a variable temperature device, a variable humidity device, a salt fog generator (8), a sky background radiation board (11), a solar radiation lamp array (12) and a rain generator (13) are mounted in a wind tunnel body (29). A wind speed sensor, a temperature sensor, a humidity sensor, a salt fog concentration sensor, a background radiation temperature sensor, a hemispherical radiometer and a rain gauge are mounted in a test section; the sky background radiation board (11) is mounted on the top of the test section of the wind tunnel, and the solar radiation lamp array (12) and the rain generator (13) are mounted on the sky background radiation board (11); the sky background radiation board (11) comprises heat conduction boards (11-2), stainless steel boards (11-3) and copper tubes (11-1); and the plurality of heat conduction boards (11-2) are divided into multiple rows and mounted on the stainless steel boards (11-3), and the copper tubes (11-1) are laid on each row of heat conduction boards (11-2). The copper tubes (11-1) are connected to an external cold and hot water device. The present invention can achieve simulation of fields of seven parameters, i.e. wind speed, temperature, humidity, solar radiation illuminance, sky effective temperature, rainfall, and salt fog in outdoor natural climate.

### FIELD OF THE INVENTION

The present disclosure relates to the field of multi-parameter environmental simulation, and in particular to a hot-humid climatic wind tunnel and a multi-field coupling control system therefor.

### BACKGROUND OF THE INVENTION

With the rapid expansion of cities and the extensive application of hard pavement materials, the urban heat island effect is increasingly serious, which affects the local climate of residents. Deteriorated climatic conditions not only affect people's physical health and thermal comfort, but also affect the healthy development of the whole city. Reducing the intensity of urban heat island and improving the urban thermal environment have attracted the attention of various countries. At the same time, under the current situation of vigorous island construction in various countries, the thermal properties of island buildings urgently need to be studied in depth. Wind tunnel test is an important method in building physical environment studies due to the advantages of continuity, repeatability, easy control of simulation parameters, no influence by outdoor weather changes, and accurate and convenient test results. However, the wind tunnel at home and abroad cannot reproduce the complex extreme salt-containing hot-humid island climate, and therefore the environmental simulation capability of a wind tunnel is highly required.

Most of the existing environmental wind tunnels cannot be applied to extreme hot-humid climates, cannot simulate high temperature, high humidity, high salt, high radiation and other complex climate conditions, and cannot realize the day-night periodic hourly adjustment and dynamic coupling control of multiple environmental parameters, which is not conducive to the elaborate study of building materials under the influence of complex climate parameters coupling. Furthermore, the existing environmental wind tunnel is limited in scale and only has partial simulation experiment capability, and it is impossible to integrate a plurality of test sections into the same wind tunnel.

### SUMMARY OF THE INVENTION

### Technical Problem

An object of the present disclosure is to overcome the drawbacks and deficiencies of the prior art and to provide a hot-humid climatic wind tunnel, which can achieve simulation of fields of seven parameters, i.e. wind speed, temperature, humidity, solar radiation illuminance, sky effective temperature, rainfall, and salt fog in outdoor natural climate.

An object of the present disclosure is to provide a multi-field coupling control system for a hot-humid climatic wind tunnel, which can realize dynamic coupling control between multi-parameter fields.

### Technical Solution

The objects of the present disclosure may be achieved by the following technical solutions. In a hot-humid climatic wind tunnel, a fan, a variable temperature device, a variable humidity device, a salt fog generator, a sky background radiation board, a solar radiation lamp array and a rain generator are mounted in a wind tunnel body, and a wind speed sensor, a temperature sensor, a humidity sensor, a salt fog concentration sensor, a background radiation temperature sensor, a hemispherical radiometer and a rain gauge are mounted in a test section. The sky background radiation board is mounted on the top of the test section of the wind tunnel, and the solar radiation lamp array and the rain generator are mounted on the sky background radiation board. The sky background radiation board includes heat conduction boards, stainless steel boards and copper tubes. The plurality of heat conduction boards are divided into multiple rows and mounted on the stainless steel boards, and the S-shaped copper tubes are laid on each row of heat conduction boards. The copper tubes are connected to an external cold and hot water device.

As a preferred technical solution, the wind tunnel body has a vertical hollow square shape, and is successively provided clockwise with a first stabilizing section, a first test section, a diffusion section, a fan section, a transition section, a contraction section, a second stabilizing section and a second test section. The first test section and the second test section are integrated in the same wind tunnel, and an atmospheric boundary layer simulation test and a hot climate simulation test may be performed at the same time.

As a preferred technical solution, a guide vane, a blocking wind valve, a heater, a guide vane, a salt fog generator, a honeycomb and a damping net are successively mounted clockwise in the first stabilizing section. The cross sections of the guide vane, the blocking wind valve, the heater, the salt fog generator, the honeycomb and the damping net are adapted to the cross section of the wind tunnel body. An outlet wind valve and an inlet wind valve are arranged on a tunnel body wall surface of the first stabilizing section. The first stabilizing section improves the flow characteristics into the first test section to create a uniformly distributed flow field within the first test section.

As a preferred technical solution, a sky background radiation board, a solar radiation lamp array and a rain generator are arranged on the tunnel body top of the first test section. A test piece groove and an air-conditioning chamber connected to the test piece groove are provided on the tunnel body bottom opposite to the sky background radiation board, the solar radiation lamp array and the rain generator. The test piece groove is configured to accommodate a test model, and the air-conditioning chamber is configured to simulate an indoor environment when the model is tested. The first test section may reproduce a complex outdoor climate environment and conduct the hot climate simulation test.

As a preferred technical solution, the diffusion section includes a honeycomb and a first round-square variable diameter tube. The honeycomb is arranged at the connection of the diffusion section and the first test section. The first round-square variable diameter tube is arranged at an inlet of the fan section and is connected to the fan in the fan section. The function of the diffusion section is to reduce the turbulence of airflow entering the fan, thereby improving the fan efficiency and prolonging the fan life.

As a preferred technical solution, a second round-square variable diameter tube, a guide vane, a surface cooler, a heater, a humidifier and a guide vane are successively mounted clockwise in the transition section. The cross section of an outlet of the second round-square variable diameter tube and the cross sections of the guide vanes, the surface cooler, the heater and the humidifier are adapted to the cross section of the wind tunnel body. The second round-square variable diameter tube is arranged at an outlet of the fan section and is connected to the fan in the fan section. The function of the transition section is to reduce the distribution of the airflow while reducing the airflow resistance.

As a preferred technical solution, the contraction section is a tapered wind tube, and both sides are tapered at an angle of 6.6°. The contraction section reduces the section of the wind tunnel, thus increasing the wind speed entering the second test section to meet the requirements of the wind speed entering the second test section.

As a preferred technical solution, a honeycomb, a damping net, a temperature stratification apparatus and a cold and hot radiation board are successively mounted clockwise in the second stabilizing section. The cross sections of the honeycomb, the damping net and the temperature stratification apparatus are adapted to the cross section of the wind tunnel body. The cold and hot radiation board is mounted on the tunnel body bottom. The second stabilizing section may improve the flow characteristics to create a uniformly distributed flow field. At the same time, a suitable temperature field is created for the second test section via the temperature stratification apparatus and the cold and hot radiation board.

Another object of the present disclosure may be achieved by the following technical solution. A multi-field coupling control system for a hot-humid climatic wind tunnel includes a data acquisition unit, an execution device unit, a central control unit and a computer operation unit. The data acquisition unit and the execution device unit are electrically connected to the central control unit, and the computer operation unit is in communication with the central control unit via a network. The data acquisition unit is mounted in a wind tunnel body, and is configured to acquire environmental parameters in the wind tunnel body, including wind speed, temperature, humidity, solar radiation illuminance, sky effective temperature, rainfall, and salt fog concentration. The execution device unit is configured to receive an instruction from the central control unit to adjust the environmental parameters in the wind tunnel body. The computer operation unit is configured to input target environmental parameters.

As a preferred technical solution, the central control unit includes an integrated control CPU module, a digital PID control module, a communication module and a power drive circuit. The integrated control CPU module is in communication with the computer operation unit via a network and is configured to read the target environmental parameters input by the computer operation unit and store data. The integrated control CPU module is connected to the digital PID control module via the communication module, and is configured to transmit the target environment parameters to the digital PID control module. The digital PID control module is connected to the power drive circuit and is configured to send a control instruction to the power drive circuit. The power drive circuit is configured to send an adjustment analog signal to the execution device unit to drive the operation of the corresponding device.

### Benefits

The present disclosure has the following advantages and benefits over the prior art.

1. In the present disclosure, the sky background radiation board and the salt fog generator are mounted in the wind tunnel, thus increasing two environmental parameters, i.e. sky effective temperature and salt fog, so as to reproduce an extreme salt-containing hot-humid island climate and improve the environmental simulation capability of the wind tunnel.

2. In the present disclosure, the multi-field coupling control system for a hot-humid climatic wind tunnel can realize the periodical hourly adjustment and coupling control of multiple environmental parameters in the wind tunnel, which can more effectively restore actual natural environment conditions and ensure the accuracy of the test.

3. In the present disclosure, the first test section and the second test section are integrated in the same wind tunnel, an atmospheric boundary layer simulation test section and a hot climate simulation test section operating in series in the same wind tunnel of a hollow square shape, and the cost for establishing wind tunnels with different test functions can be reduced.

4. The present disclosure breaks through the size limitation of existing wind tunnels at home and abroad, whereby the test function of the wind tunnel is expanded, thus providing a new experimental platform for the study of complex architectural physical phenomena in the extreme salt-containing hot-humid climatic environment of the mainland and islands.

### BRIEF DESCRIPTION OF THE DRAWINGS

FIG. 1 is a diagram of a three-dimensional model of a hot-humid climatic wind tunnel according to an embodiment of the present disclosure;

FIG. 2 is a plan view of a hot-humid climatic wind tunnel according to an embodiment of the present disclosure;

FIG. 3 is a longitudinal sectional view of a hot-humid climatic wind tunnel according to an embodiment of the present disclosure;

FIG. 4 is a schematic structure diagram of a sky background radiation board according to an embodiment of the present disclosure; and

FIG. 5 is a flowchart of a multi-field coupling control system according to an embodiment of the present disclosure.

In the drawings: 1: outer wall surface; 2: polyurethane insulation material; 3: inner wall surface; 4: outlet wind valve; 5: blocking wind valve; 6: heater; 7: inlet wind valve; 8: salt fog generator; 9: honeycomb; 10: damping net; 11: sky background radiation board; 11-1: copper tube; 11-2: aluminum heat conduction board; 11-3: stainless steel board; 12: solar radiation lamp array; 13: rain generator; 14: test piece groove; 15: air-conditioning chamber; 16: honeycomb; 17: first round-square variable diameter tube; 18: fan; 19: second round-square variable diameter tube; 20: surface cooler; 21: heater; 22: humidifier; 23: honeycomb; 24: damping net; 25: temperature stratification apparatus; 26: cold and hot radiation board; 27: scale test model; 28: guide vane; 29: wind tunnel body; 30: control room; 31: material room; 32: device area; 32-1: refrigerator unit; 32-2: cold water tank; 32-3: hot water tank; 32-4: cooling tower; 32-5: dehumidifier; 32-6: power control system; 33: test section inlet; and 34: observation window.

### DETAILED DESCRIPTION OF THE EMBODIMENTS

The present disclosure will be described below in further detail with reference to embodiments and drawings, but implementations of the present disclosure are not limited thereto.

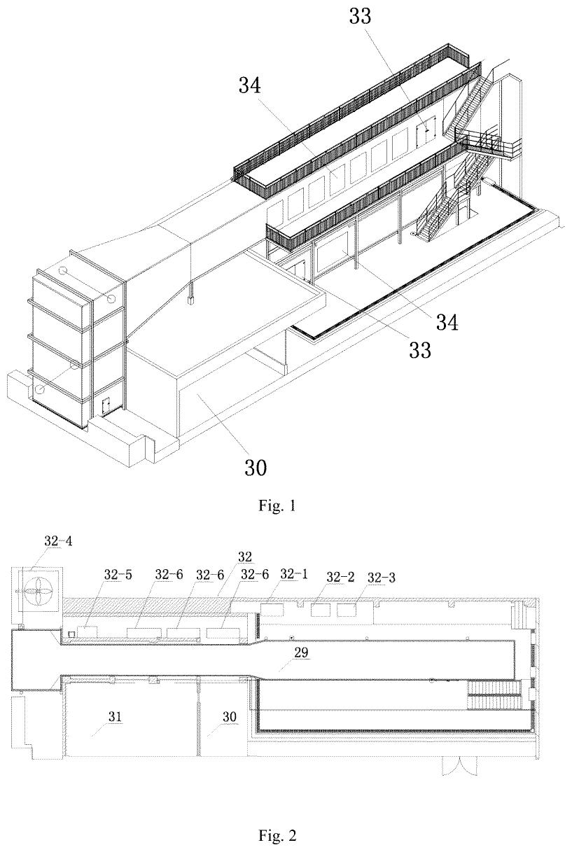

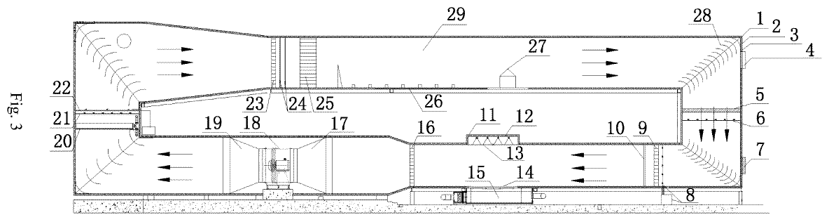

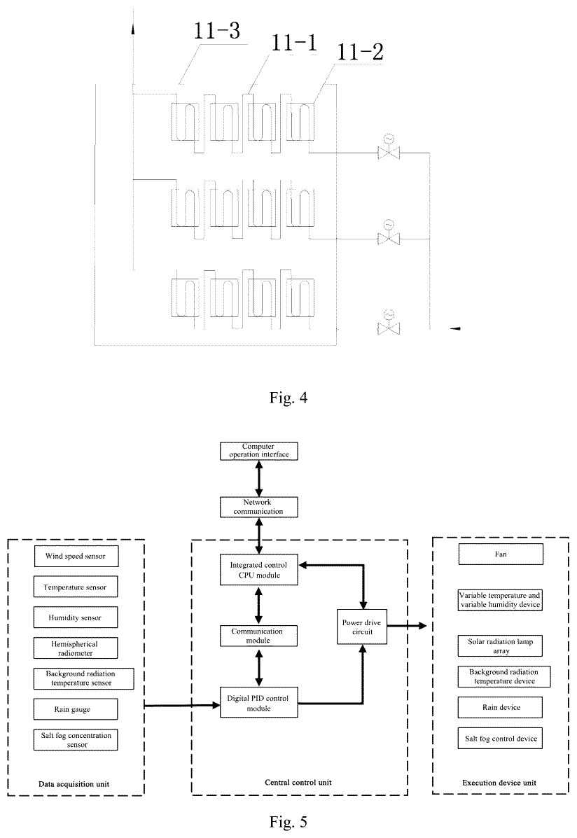

As shown in FIGS. 1-2, a hot-humid climatic wind tunnel includes a wind tunnel body, a control room, a material room and a device area. The wind tunnel body is arranged at a middle position. The control room and the material room are located on the same side of the wind tunnel body and adjacent horizontally. The device area is opposite to the control room and the material room on the other side of the wind tunnel body. The control room is configured to accommodate a wind tunnel control system computer and some experimental data acquisition units. The material room is configured to store material components and models required for wind tunnel experiments, so as to be directly taken and replaced during wind tunnel experiments, thus saving time and material resources. The device area is configured to accommodate a refrigerator unit required for temperature control of the wind tunnel, a dehumidifier required for humidity control, and a power control system required for power control. The refrigerator unit is connected to a cooling tower, a cold water tank and a hot water tank, and is connected to a heater and a surface cooler in the wind tunnel body at the same time and configured to adjust the temperature in the wind tunnel body. The dehumidifier is connected to a humidifier in the wind tunnel body and is configured to adjust the humidity in the wind tunnel body. The power control system is connected to the wind tunnel control system.

In this embodiment, the hot-humid climatic wind tunnel is a return vertical wind tunnel with a total length of 40.3 m, a maximum width of 4.9 m and a maximum height of 10.4 m. An outer wall surface of the wind tunnel body is a color steel board, and an inner wall surface is 316 stainless steel. A polyurethane insulation material with a thickness of 100 mm is filled between the inner and outer wall surfaces, so as to achieve the purposes of heat preservation, thermal insulation, moisture resistance, anti-corrosion and energy saving. The wind tunnel body is successively provided clockwise with a first stabilizing section, a first test section, a diffusion section, a fan section, a transition section, a contraction section, a second stabilizing section and a second test section.

A guide vane, a blocking wind valve, a heater 6, a guide vane, a salt fog generator, a honeycomb 9 and a damping net 10 are successively mounted clockwise in the first stabilizing section. The cross sections of the guide vane, the blocking wind valve, the heater 6, the salt fog generator, the honeycomb 9 and the damping net 10 are adapted to the cross section of the wind tunnel body. The guide vane is configured to guide air, and the blocking wind valve is configured to adjust the volume of wind. The heater 6 is configured to heat the air. The honeycomb 9 is a hexagonal honeycomb with a small loss coefficient, which is formed by hot pressing a honeycomb lattice of a resin structure, and has a length-to-diameter ratio of 10 and a length of 300 mm. The honeycomb 9 may direct airflow and reduce the turbulence, thus effectively improving the airflow characteristics of the first stabilizing section. The damping net 10, sized at 20 mesh/inch, is arranged at an inlet of the first test section, so as to achieve a uniformly distributed flow field in the wind tunnel body. The salt fog generator is configured to generate a thick fog containing salt to simulate salt fog concentrations in coastal and island climate zone environments. An outlet wind valve and an inlet wind valve are further arranged on a tunnel body wall surface of the first stabilizing section. The first stabilizing section mainly improves the flow characteristics into the first test section to create a uniformly distributed flow field within the first test section.

A sky background radiation board, a solar radiation lamp array and a rain generator are arranged on the tunnel body top of the first test section. A test piece groove and an air-conditioning chamber connected to the test piece groove are provided on the tunnel body bottom opposite to the sky background radiation board, the solar radiation lamp array and the rain generator. The sky background radiation board is mounted on the top of the first test section, and the solar radiation lamp array and the rain generator are mounted on the sky background radiation board. The solar radiation lamp array may simulate solar radiation. The rain generator may spray water from a raindrop simulating sprayer provided therewith for simulating the climate of rainfall. A hemispherical radiometer and a rain gauge are mounted in the first test section. A sky background radiation temperature sensor is mounted on the sky background radiation board. The hemispherical radiometer is configured to measure solar radiation illuminance. The sky background radiation temperature sensor is configured to measure the surface temperature of the sky background radiation board. The rain gauge is configured to measure rainfall.

The sky background radiation board includes aluminum heat conduction boards, stainless steel boards and copper tubes. The twelve heat conduction boards are divided into three rows and mounted on the stainless steel boards, and the S-shaped copper tubes are laid on each row of aluminum heat conduction boards. The copper tubes are connected to an external cold and hot water device. An outer surface of the stainless steel board is flush with the top wall surface of the wind tunnel, and the copper tube is filled with cold (hot) water. By adjusting the water temperature in the copper tube, the temperature of an inner surface of the stainless steel board may be adjusted to achieve uniform distribution of sky effective temperature, for simulating the sky effective temperature at night.

The test piece groove is configured to accommodate a test model and a material test piece. The test piece groove has an area of 2.5 m×2.5 m and is composed of five 0.5 m×2.5 m movable modules. The number of the movable modules may be adjusted according to the experimental requirements. An air-conditioning chamber is provided directly below the test piece groove. A 2HP air-cooled compression condenser unit and an electric heater with a power of 6 kW are mounted in the air-conditioning chamber for adjusting the temperature in the air-conditioning chamber. In order to ensure the uniformity of an indoor wind field and temperature field, perforated board type wind ports are adopted as a wind supply port and a wind outlet in the air-conditioning chamber. The test model is placed in the test piece groove. One side of the model is an external environment simulated by the wind tunnel, and the other side is an indoor environment simulated by the air-conditioning chamber, so as to realize the consistency between internal and external boundary conditions of the model and actual indoor and outdoor hot-humid boundary conditions, and improve the accuracy of the experiment. The length, width and height of the first test section are 3 m×3 m×2.5 m, and the first test section mainly reproduces a complex outdoor climate environment and conducts the hot climate simulation test.

A wind speed sensor, a temperature sensor, a humidity sensor and a salt fog concentration sensor are mounted on a cross section of 1 m from the inlet of the first test section. The distance between the sensor and the bottom of the wind tunnel body is 1.25 m. The wind speed sensor is configured to measure the wind speed in the first test section. The temperature sensor is configured to measure the temperature in the first test section. The humidity sensor is configured to measure the humidity in the first test section. The salt fog concentration sensor is configured to measure the salt fog concentration in the first test section.

The diffusion section includes a honeycomb 16 and a first round-square variable diameter tube 17. The honeycomb 16 is arranged at the connection of the diffusion section and the first test section and is configured to direct airflow. The first round-square variable diameter tube 17 is a wind tube component having a circular outlet at one end and a square outlet at the other end. Since the selected fan outlet in the fan section is circular, the cross section of the wind tunnel body is square. Therefore, it is necessary to connect both ends of the fan by using the first round-square variable diameter tube to reduce the division of airflow. By numerical simulation, the length of the first round-square variable diameter tube 17 of the section is set to 1.75 m. The function of the diffusion section is to reduce the turbulence of airflow entering the fan, thereby improving the fan efficiency and prolonging the fan life.

A fan is arranged in the fan section, and the fan is a variable-frequency axial-flow fan with a wind volume of 13500-270000 m³/h, a motor power of 110 KW, and a diameter of 2 m, so as to achieve airflow with an adjustable wind speed of 0.5-10 m/s in the test section of the wind tunnel. The fan can not only drive the flow and circulation of air in the whole wind tunnel space, but also realize the circulation of hot and cold capacities of a heat exchanger driven by airflow in high and low temperature environments, and meet the requirements of wind speed in climatic environment such as rainfall.

A second round-square variable diameter tube 19, a guide vane, a surface cooler, a heater 21, a humidifier and a guide vane are successively mounted clockwise in the transition section. The cross section of an outlet of the second round-square variable diameter tube 19 and the cross sections of the guide vanes, the surface cooler, the heater 21 and the humidifier are adapted to the cross section of the wind tunnel body. The second round-square variable diameter tube 19 is arranged at an outlet of the fan section and is connected to the fan in the fan section. The length of the second round-square variable diameter tube 19 of this section is also set to be 1.75 m. The guide vane is configured to guide air. The surface cooler and the heater 21 are connected to the refrigerator unit outside the wind tunnel body for adjusting the temperature in the tunnel body. The humidifier is connected to the dehumidifier outside the wind tunnel body for adjusting the humidity in the tunnel body. The function of the transition section is to reduce the distribution of the airflow while reducing the airflow resistance.

The contraction section is a tapered wind tube, and both sides are tapered at an angle of 6.6°. The contraction section reduces the section of the wind tunnel, thus increasing the wind speed entering the second test section to meet the requirements of the wind speed entering the second test section.

A honeycomb 23, a damping net 24, a temperature stratification apparatus and a cold and hot radiation board are successively mounted clockwise in the second stabilizing section. The cross sections of the honeycomb 23, the damping net 24 and the temperature stratification apparatus are adapted to the cross section of the wind tunnel body. The cold and hot radiation board is mounted on the tunnel body bottom. The second stabilizing section may improve the flow characteristics to create a uniformly distributed flow field. At the same time, a suitable temperature field is created for the second test section via the temperature stratification apparatus and the cold and hot radiation board.

A scale test model may be placed in the second test section. A speed boundary layer and a temperature boundary layer of an atmospheric boundary layer may be simulated by the scale test model for studying urban wind and hot environments and pollutant diffusion. A wind speed sensor and a temperature sensor are mounted on a cross section of 1 m from the inlet of the second test section. The distance between the sensor and the bottom of the wind tunnel body is 1.25 m. The wind speed sensor is configured to measure the wind speed in the second test section. The temperature sensor is configured to measure the temperature in the second test section.

In this embodiment, the first test section and the second test section are integrated in the same wind tunnel, an atmospheric boundary layer simulation test section and a hot climate simulation test section operating in series in the same wind tunnel of a hollow square shape, and the cost for establishing wind tunnels with different test functions can be reduced. In addition, two test sections have wind tunnel observation windows. The wind tunnel observation windows adopt double-layer toughened glass capable of heat preservation and thermal insulation, and are externally provided with movable insulation doors to ensure observation and avoid the influence of outdoor solar radiation on some experiments. A test section inlet is provided outside the wind tunnel body of both the first test section and the second test section.

In order to realize coupling control among multiple parameters in the hot-humid climatic wind tunnel, as shown in FIG. 5, a multi-field coupling control system for a hot-humid climatic wind tunnel includes a data acquisition unit, an execution device unit, a central control unit and a computer operation unit. An output end of the data acquisition unit is connected to an input end of the central control unit. An output end of the central control unit is connected to an input end of the execution device unit. The computer operation unit is in communication with the central control unit via a network.

The data acquisition unit is mounted in a wind tunnel body, includes a wind speed sensor, a temperature sensor, a humidity sensor, a hemispherical radiometer, a sky background radiation temperature sensor, a rain gauge and a salt fog concentration sensor, and is configured to acquire environmental parameters in the wind tunnel body, including wind speed, temperature, humidity, solar radiation illuminance, sky effective temperature, rainfall, and salt fog concentration. The execution device unit includes a fan, a heater, a surface cooler, a humidifier, a solar lamp array, a sky background radiation board, a rain generator and a salt fog generator. The execution device unit is configured to receive an instruction from the central control unit to adjust the environmental parameters in the tunnel body. The computer operation unit is based on programmable software, and is configured to provide a real-time display function of an operation state of each device of the device execution unit, a preset import function of target environmental parameter data changing periodically day and night, and an export of acquired data.

The central control unit is configured to receive the target environmental parameter data transmitted by the computer operation unit and internal environmental parameter data acquired by the data acquisition unit, compare the two data, output a corresponding adjustment control signal according to the operation result, control the operation of each execution device and stabilize the controlled parameters. The central control unit includes an integrated control CPU module, a digital PID control module, a communication module and a power drive circuit. The integrated control CPU module is in communication with the computer operation unit via a network and is configured to read the target environmental parameters input by the computer operation unit and store data. The integrated control CPU module is connected to the digital PID control module via the communication module, and is configured to transmit the target environment parameters to the digital PID control module. The digital PID control module is connected to the power drive circuit and is configured to send a control instruction to the power drive circuit. The power drive circuit is configured to send an adjustment analog signal to the execution device unit to drive the operation of the corresponding device. The central control unit combines analog closed-loop PID control and device logic control to make each control loop run normally, adjusts and quickly and stably reaches required values of experimental conditions, and lays the foundation for the periodical adjustment and coupling control of multiple parameters in the wind tunnel.

In order to facilitate manual intervention and control, the integrated control CPU module is also connected to the power drive circuit, and the power drive circuit may be controlled by manually setting and outputting an electrical signal, so as to realize the adjustment and control of execution device power.

The hot-humid climatic wind tunnel of the present disclosure has an adjustable wind speed of 0.5-10 m/s, a temperature of 10-40° C., a humidity of 40-98%, a solar radiation illuminance of 0-1000 W/m², a sky effective temperature of 7-45° C., a rainfall intensity of 5-200 mm/h, and a salt fog concentration of 0.3-25 mg/m³.

With an air temperature and humidity coupling control process and a wind speed and sky effective temperature control process, the working principle of the multi-field coupling control system for a wind tunnel is explained.

Firstly, the digital PID control module reads periodically changing time and corresponding air temperature and humidity. The temperature and humidity sensor feeds back actual air temperature and humidity in the test section to the digital PID control module. The digital PID control module calculates a difference between set values of air temperature and humidity and actual values, and controls the operation of air temperature and humidity adjusting devices such as a surface cooler, a heater and a humidifier, so as to adjust the air temperature and humidity to the vicinity of the set temperature and humidity and achieve stability.

If the digital PID control module detects that the temperature of the surface cooler is lower than a dew point temperature of air during the cooling and dehumidification process, there will be a condensation phenomenon in the direct dry cooling of the air, resulting in severe fluctuation of air humidity. At this moment, the digital PID control module firstly drives the gauge cooler to operate via the power drive circuit, so that the air is preliminarily cooled by the surface cooler. Then, the digital PID control module drives the dehumidifier to operate via the power drive circuit to isothermally dehumidify the preliminarily cooled air to a humidity set value. Finally, the digital PID control module restarts the surface cooler to operate via the power drive circuit, and the dehumidified air is secondarily cooled by the surface cooler to a temperature set value, thereby reaching the set temperature and humidity. In the whole process, the temperature and humidity sensor feeds back the actual air temperature and humidity in the test section to the digital PID control module in real time.

If the digital PID control module detects that the temperature of the surface cooler is higher than the dew point temperature of the air via information fed back by the temperature and humidity sensor, the digital PID control module starts the surface cooler via the power drive circuit, directly allows the air for dry cooling to the set temperature by the surface cooler without dew condensation. Then, the digital PID control module drives the dehumidifier via the power drive circuit to isothermally dehumidify the cooled air to the humidity set value, so as to reach the set temperature and humidity. The whole adjustment process fully combines the advantages of cooling dehumidification and rotary dehumidification. Not only the adjustment is convenient and smooth, but also energy consumption, device investment and operating costs are reduced.

In the wind speed adjustment process, firstly, the digital PID control module reads a wind speed set value input by the computer operation unit, and then compares an actual wind speed value (feedback) measured by the wind speed sensor with the set value. After difference calculation, the frequency of a frequency converter is automatically adjusted by the power drive circuit to change the speed of a fan motor. Then, the wind speed of the test section is adjusted, and finally the wind speed of the test section is stabilized to the vicinity of the set value.

In the sky effective temperature control process, the central control unit reads a sky effective temperature value input by the computer operation unit which periodically changes hourly, and then compares the temperature value fed back by the temperature sensor with the set value. After difference calculation, the output of a temperature analog quantity is controlled, so as to control a mixing ratio of cold and hot water in the copper tube entering the sky background radiation board, thereby achieving the periodic hourly adjustment of the sky effective temperature.

The above-described embodiments express only a few implementations of the present disclosure, which are described in greater detail but are not to be construed as limiting the scope of the present disclosure. It will be appreciated by those of ordinary skill in the art that numerous variations and modifications may be made to the present disclosure without departing from the concept of the present disclosure, which fall within the protection scope of the present disclosure. Therefore, the protection scope of the present disclosure shall be determined by the appended claims.

1. A hot-humid climatic wind tunnel, wherein a fan, a variable temperature device, a variable humidity device, a salt fog generator, a sky background radiation board, a solar radiation lamp array and a rain generator are mounted in a wind tunnel body, and a wind speed sensor, a temperature sensor, a humidity sensor, a salt fog concentration sensor, a background radiation temperature sensor, a hemispherical radiometer and a rain gauge are mounted in a test section; the sky background radiation board is mounted on the top of the test section of the wind tunnel, and the solar radiation lamp array and the rain generator are mounted on the sky background radiation board; the sky background radiation board comprises heat conduction boards, stainless steel boards and copper tubes; the plurality of heat conduction boards are divided into multiple rows and mounted on the stainless steel boards, and the copper tubes are laid on each row of heat conduction boards; and the copper tubes are connected to an external cold and hot water device.

2. The hot-humid climatic wind tunnel according to claim 1, wherein the wind tunnel body has a vertical hollow square shape, and is successively provided clockwise with a first stabilizing section, a first test section, a diffusion section, a fan section, a transition section, a contraction section, a second stabilizing section and a second test section.

3. The hot-humid climatic wind tunnel according to claim 2, wherein a guide vane, a blocking wind valve, a heater, a guide vane, a salt fog generator, a honeycomb and a damping net are successively mounted clockwise in the first stabilizing section, the cross sections of the guide vane, the blocking wind valve, the heater, the salt fog generator, the honeycomb and the damping net are adapted to the cross section of the wind tunnel body, and an outlet wind valve and an inlet wind valve are arranged on a tunnel body wall surface of the first stabilizing section.

4. The hot-humid climatic wind tunnel according to claim 2, wherein a sky background radiation board, a solar radiation lamp array and a rain generator are arranged on the tunnel body top of the first test section; a test piece groove and an air-conditioning chamber connected to the test piece groove are provided on the tunnel body bottom opposite to the sky background radiation board, the solar radiation lamp array and the rain generator; and the test piece groove is configured to accommodate a test model, and the air-conditioning chamber is configured to simulate an indoor environment when the model is tested.

5. The hot-humid climatic wind tunnel according to claim 2, wherein the diffusion section comprises a honeycomb and a first round-square variable diameter tube, the honeycomb is arranged at the connection of the diffusion section and the first test section, and the first round-square variable diameter tube is arranged at an inlet of the fan section and is connected to the fan in the fan section.

6. The hot-humid climatic wind tunnel according to claim 2, wherein a second round-square variable diameter tube, a guide vane, a surface cooler, a heater, a humidifier and a guide vane are successively mounted clockwise in the transition section; the cross section of an outlet of the second round-square variable diameter tube and the cross sections of the guide vanes, the surface cooler, the heater and the humidifier are adapted to the cross section of the wind tunnel body; and the second round-square variable diameter tube is arranged at an outlet of the fan section and is connected to the fan in the fan section.

7. The hot-humid climatic wind tunnel according to claim 2, wherein the contraction section is a tapered wind tube, both sides being tapered at an angle of 6.6°.

8. The hot-humid climatic wind tunnel according to claim 2, wherein a honeycomb, a damping net, a temperature stratification apparatus and a cold and hot radiation board are successively mounted clockwise in the second stabilizing section, the cross sections of the honeycomb, the damping net and the temperature stratification apparatus are adapted to the cross section of the wind tunnel body, and the cold and hot radiation board is mounted on the tunnel body bottom.

9. A multi-field coupling control system for a hot-humid climatic wind tunnel, comprising a data acquisition unit, an execution device unit, a central control unit and a computer operation unit, wherein the data acquisition unit and the execution device unit are electrically connected to the central control unit, and the computer operation unit is in communication with the central control unit via a network; the data acquisition unit is mounted in a wind tunnel body, and is configured to acquire environmental parameters in the wind tunnel body, comprising wind speed, temperature, humidity, solar radiation illuminance, sky effective temperature, rainfall, and salt fog concentration; the execution device unit is configured to receive an instruction from the central control unit to adjust the environmental parameters in the wind tunnel body; and the computer operation unit is configured to input target environmental parameters.

10. The multi-field coupling control system for a hot-humid climatic wind tunnel according to claim 9, wherein the central control unit comprises an integrated control CPU module, a digital PID control module, a communication module and a power drive circuit; the integrated control CPU module is in communication with the computer operation unit via a network and is configured to read the target environmental parameters input by the computer operation unit and store data; the integrated control CPU module is connected to the digital PID control module via the communication module, and is configured to transmit the target environment parameters to the digital PID control module; the digital PID control module is connected to the power drive circuit and is configured to send a control instruction to the power drive circuit; and the power drive circuit is configured to send an adjustment analog signal to the execution device unit to drive the operation of the corresponding device.
